(19) United States
(12) Patent Application Publication
(10) Pub. No.: US 2024/0004453 A1
(43) Pub. Date: Jan. 4, 2024

(54) TECHNIQUES FOR REDUCING PROCESSOR POWER CONSUMPTION

(71) Applicants: Advanced Micro Devices, Inc., Santa Clara, CA (US); ATI Technologies ULC, Markham (CA)

(72) Inventors: Ashwini Chandrashekhara Holla, Markham (CA); Alexander S. Duenas, Markham (CA); Xinzhe Li, Markham (CA); Indrani Paul, Austin, TX (US); Karthik Rao, Austin, TX (US)

(73) Assignees: Advanced Micro Devices, Inc., Santa Clara, CA (US); ATI Technologies ULC, Markham (CA)

(21) Appl. No.: 17/854,858

(22) Filed: Jun. 30, 2022

(51) Int. Cl. G06F 1/324

(52) U.S. Cl. CPC G06F 1/324

(57) ABSTRACT

Methods and systems are disclosed for managing the power consumed by cores of a system on chip (SoC). Techniques disclosed include obtaining application information that is indicative of an application being executed on the cores, detecting a workload associated with the application, and limiting one or more operating frequencies of the cores responsive to the detection of the workload. Techniques disclosed also include profiling the detected workload and limiting the one or more operating frequencies of the cores based on the profiling.

### CROSS REFERENCE TO RELATED APPLICATIONS

This application is related to co-pending application entitled “Rest-of-Chip Power Optimization Through Data Fabric Performance State Management”, Attorney Docket No. AMDATI-210722-US-ORG1, filed on the same date, which is incorporated by reference as if fully set forth herein.

### BACKGROUND

In a silent compute mode, the power consumed by a computer, including a system on chip (SoC), should be kept low. That is because an increase in power consumption is likely to trigger the cooling system of the computer to dissipate the heat, mostly by operating a fan. The noise generated by the fan impairs the user experience. Some types of applications, such as videoconferencing applications or other applications, concurrently engage several system components of the SoC with intensive workloads. Allocating sufficient power to those system components is usually aimed to satisfy performance levels required by the workloads executed by the respective components. Thus, to secure a good user experience, techniques are needed to maintain low power consumption while not compromising the performance of workloads.

### BRIEF DESCRIPTION OF THE DRAWINGS

A more detailed understanding may be had from the following description, given by way of example in conjunction with the accompanying drawings wherein:

FIG. 1 is a block diagram of an example device containing SoC, based on which one or more features of the disclosure can be implemented;

FIG. 2 is a functional block diagram of an example system for managing the power consumed by cores of an SoC, based on which one or more features of the disclosure can be implemented; and

FIG. 3 is a flowchart of an example method for managing the power consumed by cores of an SoC, based on which one or more features of the disclosure can be implemented.

### DETAILED DESCRIPTION

Systems and methods are disclosed for managing the power consumed by cores in an SoC. Techniques are disclosed for limiting the operating frequencies of the cores during certain workload types to support a silent compute mode. Hence, upon detection of specific intensive workloads, the cores' operating frequencies can be limited based on a profile of the detected workload.

In an example where the intensive workload is videoconferencing, the is performed based on the videoconferencing configuration. A videoconferencing configuration can be defined, for example, based on parameters associated with the processing of incoming and outgoing video streams, the videoconferencing application status, and display information. Limiting the operating frequencies reduces SoC's power consumption during videoconferencing that, in turn, enables operation in a silent compute mode.

Aspects of the present disclosure describe methods for managing the power consumed by cores of an SoC. The methods comprise obtaining, by a platform driver of the SoC, application information; detecting, by the platform driver, a workload associated with the application; and, in response to a detection of the workload, limiting, by a power controller, one or more operating frequencies of the cores.

Aspects of the present disclosure also describe systems for managing the power consumed by cores of an SoC. The systems comprise at least one processor and memory storing instructions. The instructions, when executed by the at least one processor, cause the processor to obtain, by a platform driver of the SoC, application information, detect, by the platform driver, a workload associated with the application, and, in response to a detection of a video workload, limit, by a power controller of the SoC, one or more operating frequencies of the cores.

Further aspects of the present disclosure describe a non-transitory computer-readable medium comprising instructions executable by at least one processor to perform methods for managing the power consumed by cores of an SoC. The methods comprise obtaining, by a platform driver of the SoC, application information, detecting, by the platform driver, a workload associated with the application, and, in response to a detection of a video workload, limiting, by a power controller, one or more operating frequencies of the cores.

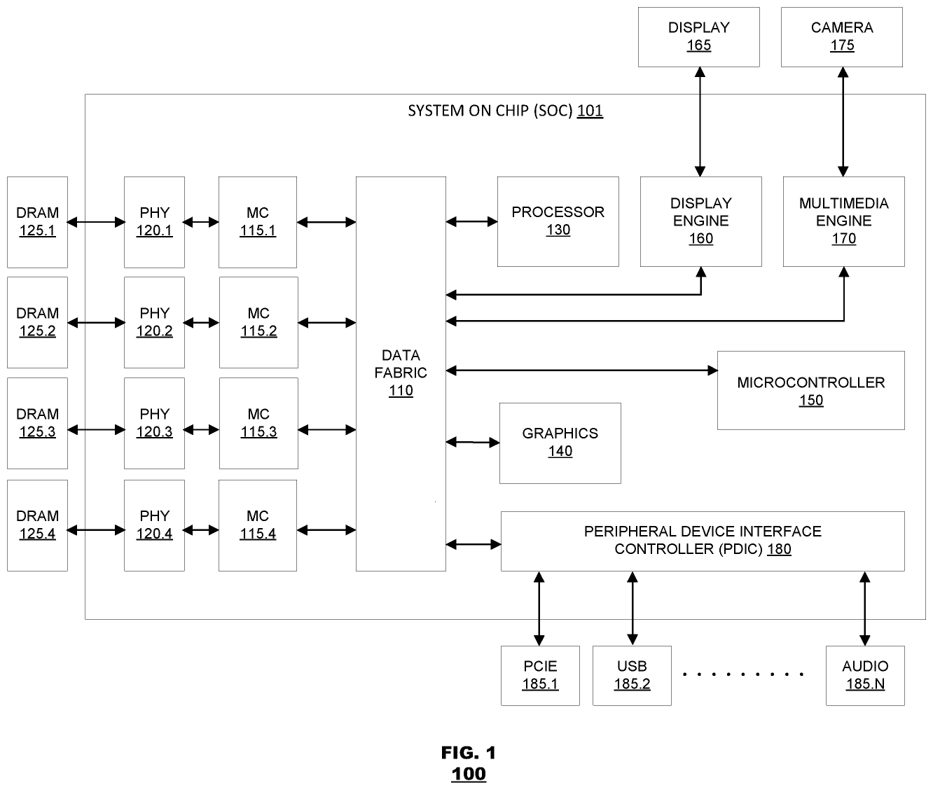

FIG. 1 is a block diagram of an example device 100 containing SoC 101. The SoC 101 includes components such as processors 130 (e.g., central processing unit or central processing unit core, sometimes referred to as “cores 130” herein), graphical processing units (GPUs 140), a microcontroller 150, a display engine 160, a multimedia engine 170, and a peripheral device interface controller (“PDIC,” sometimes referred to herein as “peripheral controller”) 180. Other components (not shown) may be integrated into the SoC 101. The processor 130, controlled by an operating system (OS) executed thereon, is configured to run applications and drivers. The graphics processing unit 140 can be employed by those applications (via the drivers) to execute computational tasks, typically involving parallel computing on multidimensional data (e.g., graphical rendering and/or processing of image data). The microcontroller 150 is configured to perform system level operations—such as assessing system performance based on performance hardware counters, tracking the temperature of the components of the SoC, and processing information from the OS. The microcontroller 150 allocates power to the different components of the SoC based on the assessed system performance. The SoC 101 further includes a data fabric 110, memory controls (MC) 115.1-4 (or, collectively, 115), and physical layers (PHYs) 120.1-4 (or 120); these components provide access to memory, e.g., DRAM units 125.1-4 (or, collectively, 125). The data fabric 110 includes a network of switchers that interconnect the SoC components 130, 140, 150, 160, 170, 180 to each other. The data fabric 110 also provides the SoC components with read and write access to the DRAM units 125.

The device 100 of FIG. 1 can be a mobile computing device, such as a laptop. In such a case, the Input/Output (I/O) ports 185.1-N (or 185) of the device—including, for example, peripheral component interconnect express (PCIE) port 185.1, universal serial bus (USB) port 185.2, and/or audio port 185.N—can be serviced by the peripheral device interface controller 180 of the SoC 101. The display 165 of the device can be connected to the display engine 160 of the SoC 101. The display engine 160 can be configured to provide the display 165 with rendered content (e.g., generated by the graphics processing unit 140) or to capture content presented on the display 165 (e.g., to be stored in the DRAM 125 or to be delivered by the PDIC 180 via one of the I/O ports 185 to a destination device or server). The camera 175 of the device can be connected to the multimedia engine 170. The multimedia engine 170 can be configured to process video captured by the camera 175, including encoding the captured video (e.g., to be stored in the DRAM 125 or to be delivered by the PDIC 180 via one of the I/O ports 185 to a destination device server).

The SoC 101 is powered by voltage rails provided by a voltage regulator. One voltage rail (namely, the core voltage rail) can supply power to the processor 130 and to the graphics processing unit 140 components, while another voltage rail (namely, the SoC voltage rail) can supply power to other components of the SoC. The voltage rails supply the SoC 101 with a total power level that is limited (by design) to the thermal design power, which indicates a maximum power the SoC 101 is capable of utilizing. Thus, power drawn by any particular SoC component can affect power drawn by any other particular SoC component. It is therefore advantageous to dynamically budget the power allocated to the SoC components based on operating conditions (e.g., whether the device is operating on battery power or using a more permanent power source) and based on performance requirements (e.g., the requirements of workloads executing on the SoC).

The data fabric 110, the main facilitator of connectivity among the SoC components and between the SoC components and the DRAM units 125, is engaged at different levels, depending on the nature of the workload that is being executed by the SoC 101. The data fabric 110 supports multiple performance states used to address different levels of activity. To maintain low power consumption while satisfying performance requirements, the setting of the data fabric performance states has to be properly managed. The power consumed by the cores 130 can also be managed to address different levels of activity. To maintain low power consumption in the cores while satisfying performance requirements of various workloads, operating frequencies of the cores can be limited, as disclosed herein. Furthermore, maintaining low power consumption by the SoC during certain workloads requires balancing conflicting demands—satisfying the performance requirement of intensive workloads while maintaining low power consumption to secure good user experience (enabling silent compute mode).

Certain types of applications, such as videoconferencing applications have proven to be demanding applications. Some such applications tend to highly engage many of the SoC components. During such applications, the processor 130 runs the applications and employs the other SoC components that communicate via the data fabric 110.

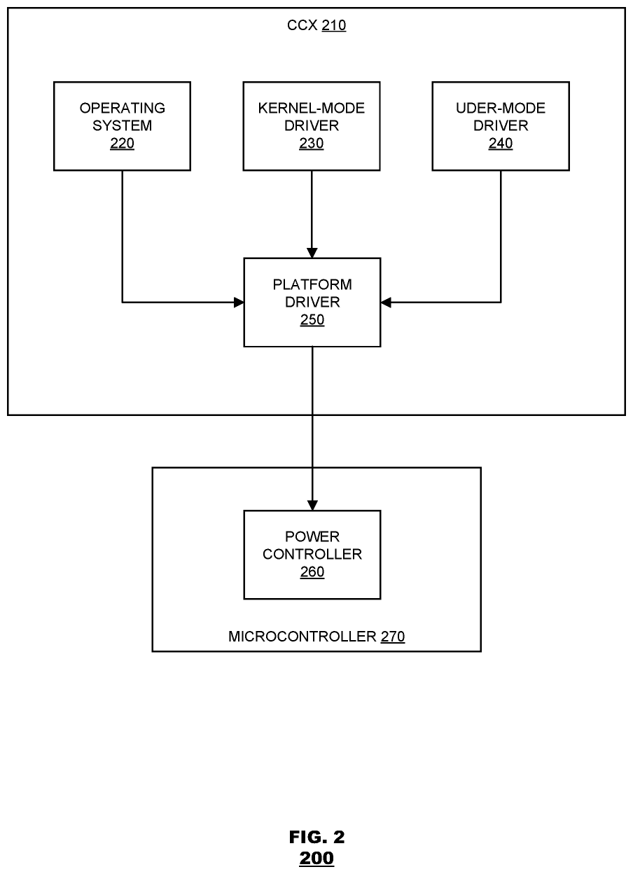

In the example of videoconferencing, many components of the SoC are active. In an example, the display engine 160 decodes and drives display of the incoming video streams of the remote conference participants. The multimedia engine 170 processes the user's video captured by the camera 175 (e.g., including enhancing the captured video using the GFX 140) and encodes the processed video before sending the encoded video out, via one of the I/O ports 185, to the other conference participants using the PDIC 180. In addition to interconnecting the SoC components, the data fabric 110 provides access to the DRAM units 125 during the conference for writing and reading of intermediate processed data that may be generated by the SoC components. When the SoC 101 is employed for videoconferencing, beneficial allocation of power to the cores 130 should be maintained so that excessive power is not supplied to the cores 130. Beneficial allocation of power to the cores can be achieved by dynamically setting the cores' 130 operating frequencies and/or power consumption, as described in reference to FIG. 2.

The techniques described herein are generally applicable where software executing on the processor 130 consumes more power than is actually needed. More specifically, some software consumes as many processing cycles as that software is allowed to consume, even if the software does not need the full capacity of the processor 130. For example, if software executes a large amount of unproductive work (such as waiting in a loop, polling hardware units, or performing other work that is considered unproductive), then the processor 130 may expend a good deal of power unnecessarily. This phenomenon occurs both where software is written inefficiently and where software utilizes and waits on hardware processing units. For example, in a videoconferencing workload, it is possible that the videoconferencing software is mostly waiting for hardware encoders and decoders to perform work. Such software could execute just as well with a smaller amount of processor cycles afforded to that software. Thus, techniques are provided herein for detecting certain types of workloads that could operate sufficiently with limited processor power. Examples of software that consumes more processing power than is necessary includes videoconferencing, other software that uses a large number of hardware accelerators, tasks that execute in the background, and thus which have workloads that could be spread over time, virus scanners, which also execute in the background and have workloads that could be spread over time, and other software that consumes more processing resources than are needed. FIG. 2 is a functional block diagram of an example system 200 for managing the power consumed by cores of an SoC. As shown in FIG. 2, the system 200 includes an operating system 220, a kernel-mode driver 230, a user-mode driver 240, and a platform driver 250, associated with cores 210 (e.g., the cores 130 of the SoC 101 of FIG. 1). The functions performed by the drivers 230, 240, 250, as disclosed herein, can be implemented by software, firmware, or hardware. Although a certain set of drivers is illustrated and described, it is possible for any set of hardware or software to perform the operations described as being performed by those drivers. For example, this disclosure contemplates one or two drivers that perform the operations ascribed to the three drivers herein.

The system 200 also includes a power controller 260 associated with a microcontroller 270 (e.g., the microcontroller 150 of the SoC 101 of FIG. 1). To support SoC operation in a silent compute mode during the execution of one or more applications, the system 200 is configured to first detect a workload deemed to be an “intensive workload” is executing, and, then, to dynamically adjust the operating frequencies of the cores 130, 210, in accordance with the nature of the workload generated by the intensive workload. To that end, the platform driver 250 is configured to detect that an intensive workload is taking place—based on information (“application information”) provided to the platform driver 250 by the operating system 220, the kernel-mode driver 230, and/or the user-mode driver 240—and to inform the power controller when such detection occurs. The power controller 260, responsive to a detection of the intensive workload, is configured to adjust the operating frequencies of the processor 130 according to the nature of the intensive workload, as further disclosed below.

The platform driver 250 is configured to detect an intensive workload by determining one or more characteristic features of an intensive workload. The platform driver 250 is capable of detecting a number of different intensive workloads, and the specific types of characteristic features used to detect each intensive workload can differ. In various examples, the following characteristic features are utilized to detect that a process (where a process is an executing software entity that has one or more threads) is an intensive workloads: file name for a workload; number of context switches per second, number of processor interrupts per second, number of threads or processes in a processor queue, percentage of time the processor is busy, percentage of time the processor is running in a privileged mode, percentage of time the processor is busy servicing the workload, percentage of time a processor is running in user mode, the execution state of the workload (where execution state means how busy the threads are—threads can be ready, running, waiting, or can be in another state), or the current priority of the process or threads of the workload. Some other example characteristic features include aspects of memory and/or storage such as access rates, average access size, or other features about memory or storage access. Some other example characteristic features include aspects of hardware accelerator performance, such as the degree to which such hardware accelerators are being utilized (e.g., percentage of active time to total amount of time), and the identity of the process from which requests to utilize the hardware accelerators originate. The platform driver 250 utilizes the above characteristic features either specific to a process (e.g., percentage of time a process is running in user mode) or a thread (e.g., percentage of time a thread is running in user mode).

In some examples, the platform driver 250 has access to data that indicates a set of intensive workloads, a corresponding set of characteristic feature data for each intensive workload, and an indication of one or more remedial actions to take for each intensive workload. For each intensive workload, the corresponding characteristic feature data indicates what characteristic features are relevant and a set of threshold values for each such characteristic feature. In addition, for each intensive workload, the corresponding one or more remedial actions indicates what action to take and the degree to which the action is performed. In an example, the one or more remedial actions indicates that the operating frequency of the processor 130 should be limited. In some examples, the one or more remedial actions indicates the degree to which the operating frequency of the processor 130 should be limited. In an example, the one or more remedial actions indicates a percentage of maximum or absolute amount to set the operating frequency to in the event that an intensive workload is detected. In some examples, the one or more remedial actions includes data that indicates how much scaling should occur based on the values of the characteristic features. In an example, as a characteristic feature increases, the scaling amount increases.

For each intensive workload, the platform driver 250 determines whether the current operating conditions associated with the device 100 meet the threshold values for each of the relevant characteristic features associated with that intensive workload. If the platform driver 250 determines that the operating conditions do meet the threshold values of each of these characteristic features, then the platform driver 250 identifies that a particular intensive workload is currently being executed and determines that the associated remedial action should be taken. The platform driver 250 identifies the remedial action to be taken, including the degree to which that remedial action is performed, and causes the remedial action to be performed.

An example is now described in which the intensive workload is videoconferencing. The characteristic features associated with videoconferencing in this example include the filename of the videoconferencing application, and the workload with hardware accelerators that include a video encoding hardware accelerator and a video decoding hardware accelerator. More specifically, in this example, the characteristic feature of filename requires that the file name of the application is a file name of a known videoconferencing application. In an example, the requirement for this characteristic feature is met in the situation that a process having one of the file names of a known videoconference application is executing. An additional characteristic feature is a threshold workload level executing in a hardware video encoder and a threshold workload level executing in a hardware video decoder. In the event that each of these characteristic features is met, the platform driver 250 determines that a videoconferencing application is executing. In this situation, the platform driver 250 limits the processing power of the processor 130. Thus, in the example, the characteristic features include the filename characteristic feature, and a set of hardware workload characteristic features, and the remedial action is limiting the processing power of the processor 130. Additional detail regarding the videoconferencing example is now provided.

To detect that videoconferencing is carried out by the user, the platform driver 250 is configured to periodically obtain supporting information to that effect from sources in the cores 210, such as the operating system 220, the kernel-mode driver 230, and the user-mode driver 240. Hence, the operating system 220 can provide information about the applications that are currently being executed by the cores, such as application executable file names. In an example, obtaining an executable name of an application informs the platform driver 250 that an application with that name is currently running on the SoC 101. Yet, further indication is still required to conclude that the workload, namely, a video workload, executed by the SoC 101, is one that is generated by an actual videoconferencing. That is, a video workload that includes the processing of incoming video streams of remote participants and capturing the outgoing video stream of the user.

Current executions of encoding jobs and/or decoding jobs by respective SoC components can indicate that the workload is generated by an actual videoconferencing. That is because actual videoconferencing involves encoding of video captured by the user's camera and decoding of incoming video streams received from remote participants. The kernel-mode driver 230—for example, via a multimedia driver (not shown) that is in charge of generating encoding and decoding jobs to respective SoC components—can be utilized to inform the platform driver 250 that such jobs are currently being executed by the SoC 101 (e.g., by the multimedia engine 170 or by the display engine 160). Thus, a kernel-mode driver 230 can provide information regarding a job currently being executed (e.g., the process ID), its type (encoding or decoding), and the job parameters (e.g., resolution, rate, or dynamic range of video frames). Using a job's process ID, the platform driver 250, can associate an encoding or a decoding job with the videoconferencing application. When encoding and/or decoding jobs (reported by the kernel-mode driver 230) can be associated with the videoconferencing application (reported by the operating system 220), the platform driver 250 can conclude that the SoC is employed by a video workload, that is, a workload that is generated by an actual videoconferencing.

The number of decoding jobs (associated with a videoconferencing application) corresponds to the number of remote participants, that is, the number of incoming video streams. The number of incoming video streams that the videoconferencing application has to handle is indicative of the nature of the workload, or how stressful the resulting workload is. Likewise, the jobs' parameters can be used to further profile the workload. Based on parameters such as resolution, rate, or dynamic range of frames of the processed videos, the necessary bandwidth can be assessed, as further discussed below. Display information, including the number of displays 165 used by the user, can also be used to profile the workload.

Further information can be provided to the platform driver 250 from the user-mode driver 240. For example, the user-mode driver can provide information regarding application status. The application status can indicate, for example, whether the videoconferencing application is running on the operating system in the background or in the foreground. The workload can be further profiled based on such information.

The information collected by the platform driver 250 from the operating system 220, the kernel-mode driver 230, and the user-mode driver 240, as described above, can be used by the platform driver to detect that the workload currently being executed by the SoC 101 is a video workload (that is, a workload that is generated by an actual videoconference) and to profile that video workload. Hence, a message indicating a detection of a video workload can be sent by the platform driver 250 to the power controller 260. In an aspect, also the profile of the detected video workload can be sent to the power controller 260.

The power controller 260 is configured to dynamically set the operating frequencies that the cores 130 operate in. That is, the voltage levels that the cores 130 are supplied with and the corresponding frequencies their clocks are set to pulse at. When the power controller 260 receives a message from the platform driver 250 that a video workload is detected and, possibly, the detected video workload's profile, the power controller 260 determines whether it is necessary to limit the power (e.g., by limiting operating frequencies and voltage) of the cores. Limiting the operating frequencies of the cores reduces the total SoC power consumption, and, thus, reduces the likelihood of starting the fan of the cooling system of the device 100, thereby supporting a silent compute mode. In an aspect, the platform driver 250 may receive information from the operating system 220 that indicates that one or more other workloads (generated by applications other than the videoconferencing application) are being executed in parallel with the video workload and may relay this information to the power controller 260. In such a case, to avoid interference with the performance of those other workloads, the power controller 260 may decide not to limit (or to reduce the amount of limiting) the operating frequencies of the cores.

The profile of the workload can be used to determine the limiting extent of the cores' operating frequencies, so that, while reducing the power consumption, the required performance level (e.g., processing speed, latency, or bandwidth) is still satisfied. In an aspect, video workloads, generated by videoconferencing under different configurations, can be profiled offline (e.g., in a calibration phase). For example, configurations that result in the processing of different numbers of incoming video streams, each having frames at different rate, resolution, and dynamic range, can be mapped to respective sets of operating frequencies, each set corresponding to different operating frequencies. The set of operating frequencies that a certain configuration is mapped to corresponds to the minimal operating frequencies that still satisfy the configuration performance requirements.

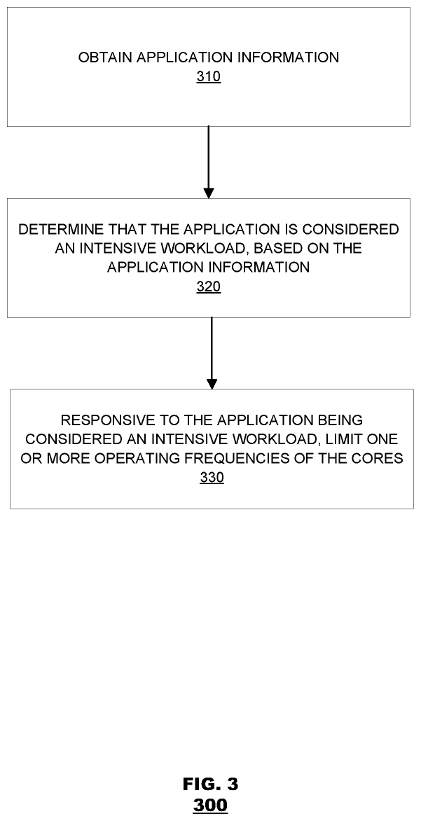

FIG. 3 is a flowchart of an example method 300 for managing the power consumed by cores of an SoC. The method 300 begins, in step 310, where application information is obtained by the platform driver 250. In some examples, the application information is the information described above that allows the platform driver 250 to determine whether an intensive workload is taking place. The application information includes information about software and/or hardware operating within the device 100. In step 320, the platform driver 250, based on the application information, determines that an intensive workload is executing within the device. In response to such a detection, in step 330, one or more operating frequencies of the cores are limited by the power controller 260.

In some examples, the intensive workload is a videoconferencing workload. In such examples, the detected video workload can include an encoding job of a captured video stream associated with the videoconferencing application and/or a decoding job of one or more incoming video streams associated with the videoconferencing application. In such examples, the platform driver 250 profiles the video workload, to facilitate the limiting of the one or more operating frequencies of the cores that can be performed based on the profiling. In an aspect, the profiling of the video workload can be based on a number of incoming video streams associated with the videoconferencing application. In another aspect, the profiling of the video workload can be based on the parameters of an encoding job or a decoding job of the video workload. Such parameters can include a resolution, a rate, or a dynamic range of frames of the video streams processed by the workload. The profiling can also be based on application status information, including whether the videoconferencing application is running on the operating system 220 in the background or in the foreground. Likewise, the profiling can also be based on display information, including the number of connected displays 165.

It should be understood that many variations are possible based on the disclosure herein. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such as instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of a non-transitory computer-readable medium include read only memory (ROM), random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for managing the power consumed by cores of a system on chip (SoC), comprising:
obtaining, by a platform driver of the SoC, application information;
detecting, by the platform driver, a workload associated with the application; and
limiting, by a power controller, one or more operating frequencies of the cores responsive to the detecting of the workload.

2. The method of claim 1, wherein the workload comprises an encoding job of a captured video stream associated with the application.

3. The method of claim 1, wherein the workload comprises a decoding job of one or more incoming video streams associated with the application.

4. The method of claim 1, further comprising:
profiling, by the platform driver, the workload, wherein the limiting of the one or more operating frequencies of the cores is based on the profiling.

5. The method of claim 4, wherein the profiling of the workload is based on a number of incoming video streams associated with the application.

6. The method of claim 4, wherein the profiling of the workload is based on parameters of an encoding job or a decoding job of the workload.

7. The method of claim 6, wherein the parameters of the encoding job or the decoding job are one of a resolution, a rate, or a dynamic range of video frames.

8. The method of claim 4, wherein the profiling is based on an application status, including whether the application is running in the background or in the foreground.

9. The method of claim 4, wherein the profiling is based on a display information, including a number of displays.

10. A system for managing the power consumed by cores of an SoC, comprising:
at least one processor; and
memory storing instructions that, when executed by the at least one processor, cause the processor to:
obtain, by a platform driver of the SoC, application information,
detect, by the platform driver, a workload associated with the application, and
limit, by a power controller of the SoC, one or more operating frequencies of the cores responsive to the detecting of the workload.

11. The system of claim 10, wherein the workload comprises an encoding job of a captured video stream associated with the application.

12. The system of claim 10, wherein the workload comprises a decoding job of one or more incoming video streams associated with the application.

13. The system of claim 10, wherein the instructions further cause the processor to:
profile, by the platform driver, the workload, wherein the limiting of the one or more operating frequencies of the cores is based on the profiling.

14. The system of claim 13, wherein the profiling of the workload is based on a number of incoming video streams associated with the application.

15. The system of claim 13, wherein the profiling of the workload is based on parameters of an encoding job or a decoding job of the workload.

16. The system of claim 15, wherein the parameters of the encoding job or the decoding job are one of a resolution, a rate, or a dynamic range of video frames.

17. The system of claim 13, wherein the profiling is based on an application status, including whether the application is running in the background or in the foreground.

18. The system of claim 13, wherein the profiling is based on a display information, including a number of displays.

19. A non-transitory computer-readable medium comprising instructions executable by at least one processor to perform a method for managing the power consumed by cores of an SoC, the method comprising:
obtaining, by a platform driver of the SoC, application information;
detecting, by the platform driver, a workload associated with the application; and
limiting, by a power controller of the SoC, one or more operating frequencies of the cores responsive to the detecting of the workload.

20. The medium of claim 19, further comprising:
profiling, by the platform driver, the workload, wherein the limiting of the one or more operating frequencies of the cores is based on the profiling.
